(19) United States
(12) Patent Application Publication
(10) Pub. No.: US 2014/0297818 A1
(43) Pub. Date: Oct. 2, 2014

(54) Parallel and Dynamic Interface Selection

(71) Applicant: MICROSOFT CORPORATION, Redmond, WA (US)

(72) Inventors: Eric N. Loewenthal, Seattle, WA (US); Ivan D. Pashov, Woodinville, WA (US); Jonathan A. Silvera, Seattle, WA (US)

(73) Assignee: Microsoft Corporation, Redmond, WA (US)

(21) Appl. No.: 13/853,910

(22) Filed: Mar. 29, 2013

(51) Int. Cl. H04L 29/06; H04L 12/24

(52) U.S. Cl. CPC H04L 65/1069; H04L 41/0816
USPC 709/221; 709/227

(57) ABSTRACT

Various embodiments enable parallel querying of multiple network interfaces for communication configuration information. Returned communication configuration information can be used by a client device to enable communication with another computing device. In some embodiments, multiple responses to the parallel queries are received. Alternately or additionally, a response from a network interface can be determined through expiration of a user-configured timeout and/or a protocol configured timeout. Selection of a network interface from the multiple responses can be based, at least in part, on prioritizing the responding network interfaces using an adaptive selection algorithm.

### BACKGROUND

Inter-connectivity between computing devices is becoming more and more prevalent. Oftentimes, a first computing device connects with a remote computing device in order to exchange data. One such example relates to a client-server relationship in which a server device has the ability to influence a behavior and/or a configuration associated with a client device. In some cases, the client device looks to the server device for dynamic network configuration information. To obtain this configuration information, the client device may send out a query to a network interface associated with the server device. If the network interface returns configuration information, the client device proceeds with its tasks based upon what was returned. However, if the interface times out and/or returns a lack of configuration information, the client device may then decide to send a new query to a second network interface. This process can repeat itself until the client device obtains the requested configuration information and/or there are no more network interfaces to query. Depending upon how many network interfaces are available, and whether the queries timeout or not, the process of locating an interface that has configuration information can sometimes be time consuming to the client device which, in turn, can delay applications running on the client device.

### SUMMARY

This Summary is provided to introduce a selection of concepts in a simplified form that are further described below in the Detailed Description. This Summary is not intended to identify key features or essential features of the claimed subject matter.

Various embodiments enable parallel querying of multiple network interfaces for communication configuration information. Returned communication configuration information can be used by a client device to enable communication with another computing device. In some embodiments, multiple responses to the parallel queries are received. Alternately or additionally, a response from a network interface can be determined through expiration of a user-configured timeout and/or a protocol configured timeout. Selection of a network interface from the multiple responses can be based, at least in part, on prioritizing the responding network interfaces using an adaptive selection algorithm.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 is an illustration of an example diagram of parallel interface probing in accordance with one or more embodiments

FIG. 4 is an illustration of an example diagram of parallel interface probing in accordance with one or more embodiments.

FIG. 5 is an illustration of an example diagram of parallel interface probing in accordance with one or more embodiments.

FIG. 6 illustrates a flow diagram in accordance with one or more embodiments.

FIG. 7 illustrates an example computing device that can be utilized to implement various embodiments described herein.

### DETAILED DESCRIPTION

Overview

Various embodiments enable parallel querying of multiple network interfaces for communication configuration information. Returned communication configuration information can be used by a client device to enable communication with another computing device. In some embodiments, multiple responses to the parallel queries are received. Alternately or additionally, a response from a network interface can be determined through expiration of a user-configured timeout and/or a protocol configured timeout. Selection of a network interface from the multiple responses can be based, at least in part, on prioritizing the responding network interfaces using an adaptive selection algorithm.

In the discussion that follows, a section entitled “Example Operating Environment” is provided and describes one environment in which one or more embodiments can be employed. Following this, a section entitled “Parallel and Dynamic Network Interface Selection” describes querying and/or probing multiple network interfaces in parallel and dynamically selecting one based on a prioritization in accordance with one or more embodiments. Last, a section entitled “Example Device” describes an example device that can be utilized to implement one or more embodiments

Having provided an overview of various embodiments that are to be described below, consider now an example operating environment in which one or more embodiments can be implemented.

Example Operating Environment

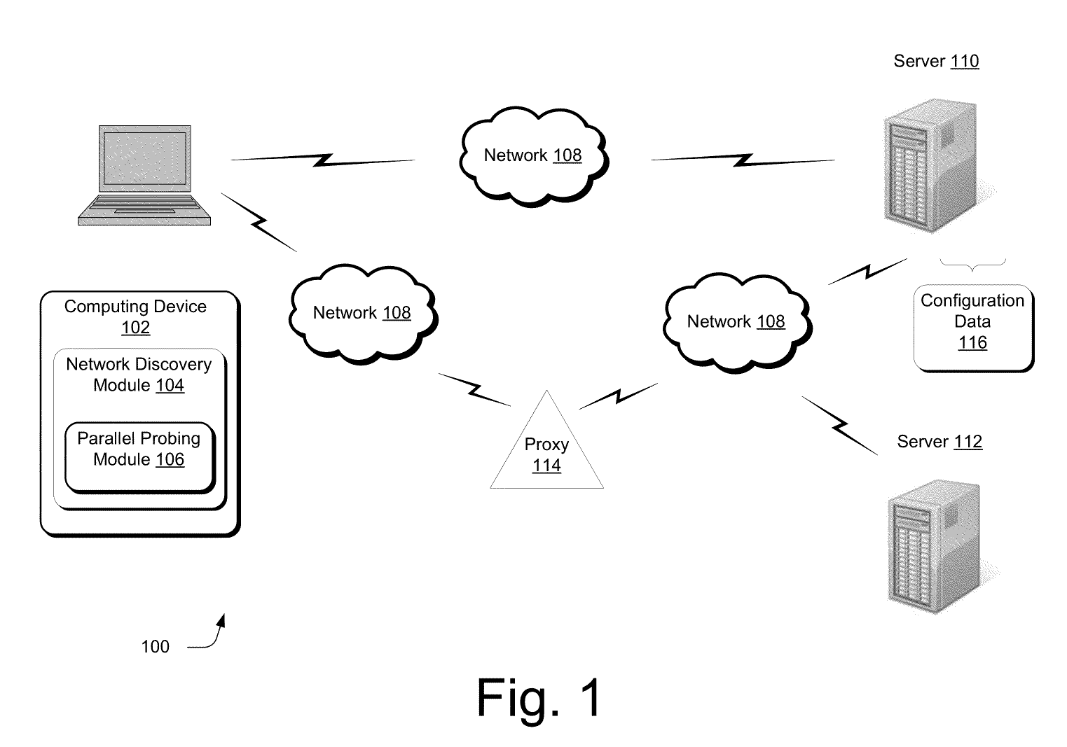

FIG. 1 is an illustration of an example environment 100 that is operable to employ the techniques described in this document. Environment 100 includes computing device 102 that may be configured in a variety of ways. For example, computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth. Thus, computing device 102 may range from full resource devices with substantial memory and processor resources (e.g., personal computers, game consoles) to a low-resource device with limited memory and/or processing resources (e.g., traditional set-top boxes, hand-held game consoles). Computing device 102 also includes software that causes computing device 102 to perform one or more operations as described below, such as network discovery module 104 and parallel probing module 106.

Network discovery module 104 represents functionality that enables computing device 102 to discover and/or find other computing devices and/or peripherals over a network. For example, network discovery module 104 can be configured to include, by way of example and not of limitation, Dynamic Host Control Protocol (DHCP) functionality, Domain Name System (DNS) functionality, Web Proxy AutoDiscovery (WPAD) protocol functionality, Windows Internet Naming Service (WINS) protocol functionality, Simple Network Management Protocol (SNMP) functionality, and so forth. In some cases, network discovery module 104 includes functionality to dynamically discover and/or connect to a network, computing device, peripheral, and so forth, without user intervention. Among other things, network discovery module 104 can receive communication configuration information from another computing device, and use this configuration information to enable connection to and/or data transfer between computing device 102 and the other computing device. In some cases, this can include configuring a connection through one or more proxies. Alternately or additionally, network discovery module 104 includes functionality to allow a user to manually configure and/or connect to a network, computing device, peripheral, and so forth.

Parallel probing module 106 represents functionality configured to probe multiple network interfaces in parallel. For example, instead of querying each network interface of the multiple network interfaces in a serial manner (e.g. send a query to a first network interface and wait for a response from the first network interface, then send a query to a second network interface and wait for a response from the second network interface, etc.), parallel probing module 106 can issue a query to each network interface of the multiple network interfaces at virtually the same time (e.g. issuing all of the network interface queries without waiting for a response from any of the network interfaces). In some embodiments, parallel probing module can receive a response or a timeout from each of the network interfaces. Alternately or additionally, parallel probing module 106 can select, from the responding network interfaces, which network interface to use by using an adaptive selection algorithm, as further described below. While illustrated as residing within network discovery module 104, it is to be appreciated and understood that parallel probing could reside external and/or be independent of network discovery module 104 without departing from the scope of the claimed subject matter.

Environment 100 also includes a network 108 which represents one or more data communication networks and/or links. For example, the network 108 may include a wide area network (WAN), a local area network (LAN), a wireless network, an intranet, the Internet, and so on. In this example, FIG. 1 illustrates network 108 as an external connection between computing device 102, servers 110 and 112, and/or proxy 114.

Server 110 represents a computing device to which computing device 102 is attempting to connect and/or exchange data with. In this example, computing device 102 is looking to server 110 for information on how to connect with server 112. However, it is to be appreciated that server 110 could be any other type of computing device, peripheral, and so forth, without departing from the scope of the claimed subject matter. Server 110 includes configuration data 116 which can be utilized by computing device to connect with server 112. Configuration data 116 can include any suitable type of communication configuration information, and can be stored in any suitable manner. For example, in some embodiments, configuration data 116 can include a Uniform Resource Locator (URL) to an additional configuration file, such as that used by WPAD methods through DHCP and/or DNS discovery techniques. Alternately or additionally, configuration data 116 can represent a proxy auto-configuration file that can be used to direct computing device 102 to connect to and/or utilize proxy 114 as part of the data transfer process with server 112. In some cases, configuration data 116 can direct computing device 102 to connect directly to server 112. Thus, configuration data 116 represents any suitable type of configuration data, such as script data, URL data, settings, addressing data, and so forth.

Proxy 114 represents functionality that acts as an intermediary between computing devices. Here, proxy 114 has connections through network 108 to computing device 102, server 110, and server 112. As such, proxy 114 can act as an intermediary between the two. While not illustrated, it is to be appreciated that proxy 114 can have additional connections to other computing devices and/or servers. Alternately or additionally, proxy 114 can mediate data transfer for computing device 102 with these other connections.

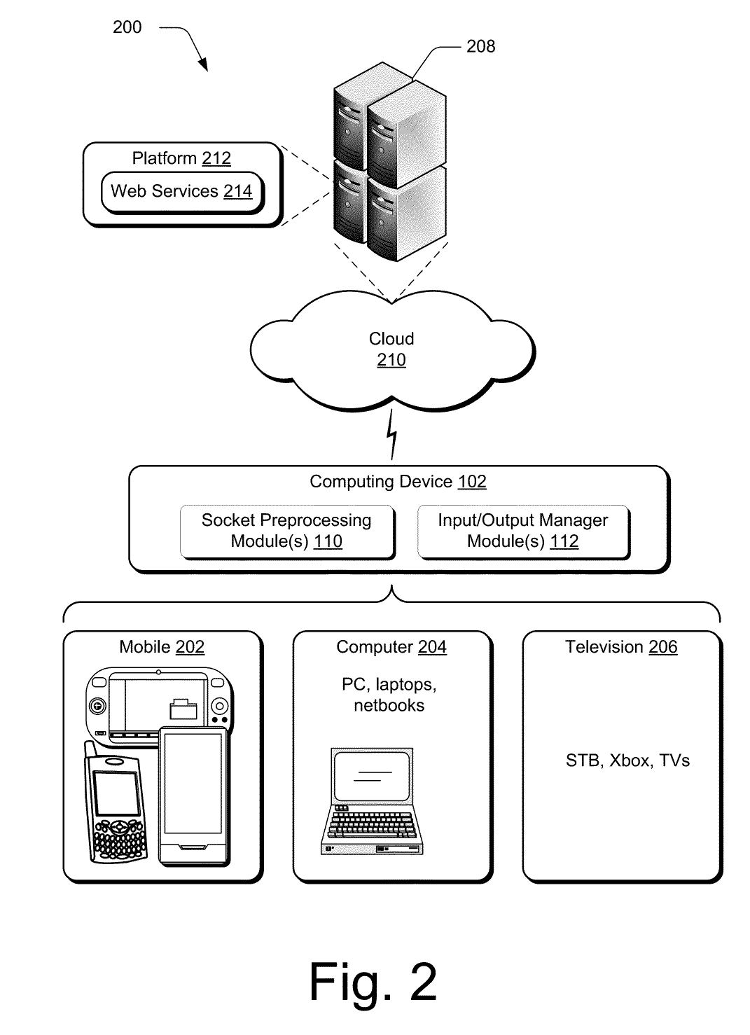

FIG. 2 illustrates an example system 200 generally showing computing device 102 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described, computing device 102 may be configured in a variety of different ways, such as for mobile 202, computer 204, and television 206 uses. Each of these configurations has a generally corresponding screen size and thus computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections. As illustrated here, computing device 102 can include network discovery module(s) 104 and parallel probing module(s) 106 as described above and below.

In some embodiments, server(s) 208 include “cloud” functionality. Here, cloud 210 is illustrated as including a platform 212 for web services 214. The platform 212 abstracts underlying functionality of hardware (e.g., servers) and software resources of the cloud 210 and thus may act as a “cloud operating system.” For example, the platform 212 may abstract resources to connect the computing device 102 with other computing devices. The platform 212 may also serve to abstract scaling of resources to provide a corresponding level of scale to encountered demand for the web services 214 that are implemented via the platform 212. A variety of other examples are also contemplated, such as load balancing of servers in a server farm, protection against malicious parties (e.g., spam, viruses, and other malware), and so on. Thus, the cloud 210 is included as a part of the strategy that pertains to software and hardware resources that are made available to the computing device 102 via the Internet or other networks.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

Having described example operating environments in which various embodiments can be utilized, consider now a discussion of parallel and dynamic network interface selection in accordance with one or more embodiments.

Parallel and Dynamic Network Interface Selection

Dynamic network and/or device discovery is a process in which a computing device can automatically discover and/or connect with other computing devices, peripherals, and so forth over a network. In some cases, the computing device directly connects with another device, while in other cases it may connect indirectly, such as through a proxy. Determining an indirect connection can also be a dynamic and/or automated process. For instance, consider WPAD. A computing device can use WPAD methods as a way to locate one or more configuration files that include information related to which proxy (or proxies) the computing device should use to access a particular domain and/or server. Locating the configuration file(s) can sometimes entail using various protocols, such as DHCP and/or DNS discovery methods.

At times, the remote computing device may have several network interface options for the computing device to choose from in order to establish a particular connection. In these cases, the computing device not only attempts to automatically configure a connection with the remote computing device, but additionally determines which network interface to connect with. One way to determine which network interface is to use is to query the multiple interfaces serially (e.g. one at a time). To begin, the computing device would query and/or probe a first network interface for communication configuration and/or connection information. The computing device then waits until the first network interface responds to the query and/or the query times out/expires. If the first network interface responds with the communication configuration and/or connection information, the computing device can use the retrieved information to establish a connection, and subsequently forgo querying any other network interfaces. Provided the first network interface responds, and responds in a timely manner, this method of serial querying can produce a stable and responsive connection process. However, if the first network interface fails to respond, and the query expires instead, this can introduce additional delay perceived by an end user of the computing device. Consider a case where there are four network interfaces being queried in a serial manner. If the computing device serially queries the first three network interfaces, and all three network interfaces timeout at 30 seconds apiece, it would take 90 seconds before the computing device proceeds to querying the fourth network interface, which eventually responds in a positive manner. Thus, while a serial method can produce a fairly seamless connection process, it can also introduction additional delays to the end user.

Various embodiments enable parallel querying of multiple network interfaces for communication configuration information. Instead of querying each network interface one at a time (and waiting for a first network interface to respond and/or time out before querying a second network interface), multiple queries are sent in parallel and without waiting for query responses. Here, a query response implies a response to the affirmative and/or negative (including timeout responses to the query) of whether the network interface has communication configuration information, and does not imply any lower level protocol handshaking responses. Thus, a response here implies a response at a same layer of processing as the request. The communication configuration information returned can then be used by a first computing device to enable communication with another computing device, such as by including connection parameters and/or information directing the first computing device to alternate connection routes and/or alternate connection parameters. In some embodiments, multiple responses to the parallel queries are received, whether directly in a message or indirectly through a timeout.

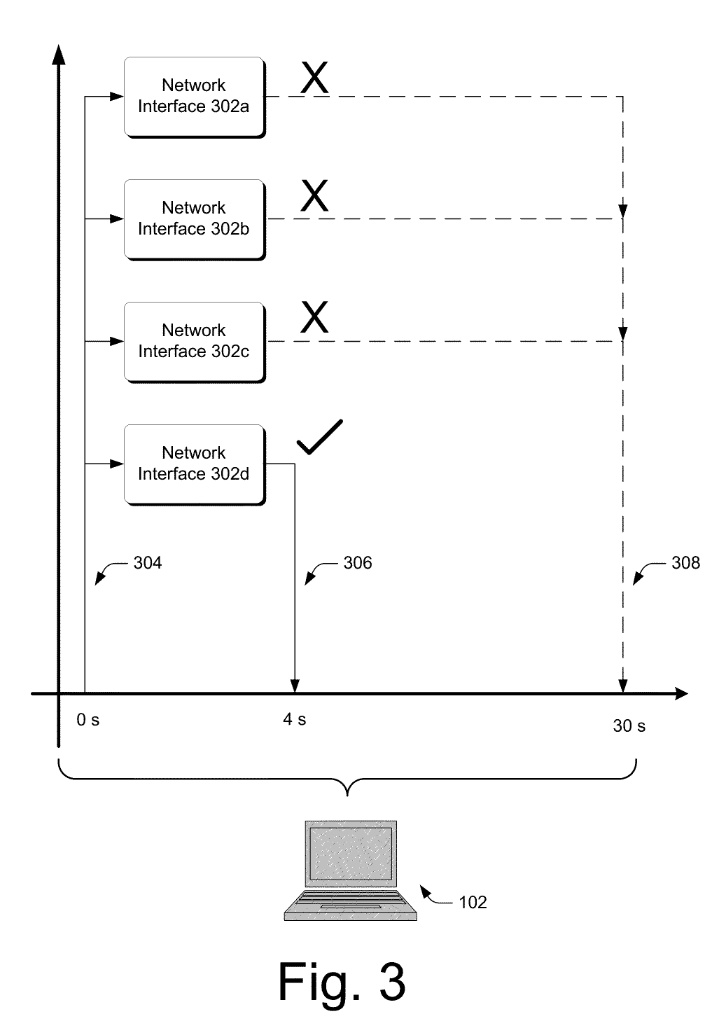

Consider FIG. 3, which illustrates an example of parallel network interface probing. Here, functionality is described in the context of computing device 102 of FIGS. 1 and 2. However, it is to be appreciated and understood that methods and/or functionality described herein can be applied to any suitable type of computing device without departing from the scope of the claimed subject matter. In this example, computing device 102 has determined that there are four network interfaces associated with a remote computing device it is trying to access: network interfaces 302a, 302b, 302c, and 302d. While this example illustrates four network interfaces, the functionality described can be applicable to any suitable number of interfaces. Alternately or additionally, computing device 102 can determine whether an associated network interface is a potential candidate for usage or not. Computing device 102 can begin by querying for all possible network interfaces. Upon determining how many available network interfaces exist, computing device 102 may next make a determination that some of the available network interfaces are inapplicable. For example, a network interface may be determined inapplicable and/or disqualified based, at least in part on a property of the network interface, such as not having DHCP enabled, not having a public unicast address, not having an address of an associated DHCP server, not having a particular version of Internet Protocol (IP) enabled (such as IPv4), and so forth. Thus, in some embodiments, not only are network interfaces identified, but they may be additionally analyzed for desired characteristics and/or applicability.

At some point in time, computing device 102 sends out four interface query messages in parallel illustrated here at indication 304. A first query message is sent to network interface 302a, a second query message is sent to network interface, 302b, and so forth. In this example, each message is illustrated as being sent at (or near) time “0” seconds (s). This is meant to indicate that each message is sent at virtually the same time. For example, in some embodiments, sending the plurality of query messages might be implemented in software as a loop, where each message is sent in rapid succession of one another, with little or no other functionality being executed in-between the messages. Alternately or additionally, there may be additional time in-between to add addressing and/or customization to each message related to the interface it is being sent to. While this implementation would not send each message at the same exact instant in time, it would send each message at effectively the same time. To further illustrate, and using the context of the above example of sending messages serially, sending query messages in parallel differs from sending message serially in that the query messages are sent to each network interface without waiting for responses or time outs from other network interfaces. While other processing may occur in-between sending the query messages, sending a query message to a network interface is not dependent upon first receiving a query response message from other outstanding queries. Thus, the parallel probing messages are sent virtually at the same time, represented here as time “0 s”.

Upon receiving the query and/or request, network interface 302d responds in a positive manner, shown here as indication 306. In this example, which is not drawn to scale on the time axis, indication 306 is returned to computing device 102 within 4 seconds of the query message being sent. While this figure displays a return time of 4 seconds, it is to be appreciated that this is merely for discussion purposes, and that any suitable time period and/or unit of time (e.g. milliseconds, nanoseconds, etc.) is equally applicable without departing from the scope of the claimed subject matter. At this point in time, computing device 102 has not received any other indications and/or responses, whether positive response or negative responses. In some embodiments, computing device 102 can use the information returned by network interface 302d to configure a connection (whether direct or indirect) with the remote computing device as soon as it is received. For example, in the interest of time, computing device 102 may utilize the first returned response without waiting for any other responses, in this case the first returned response being indication 306. Alternately or additionally, computing device 102 may first wait for a response and/or timeout from all queries before configuring a connection, as further described below.

In some embodiments, network interface 302d returns information and/or data similar to the communication configuration information described above and below. For example, the query from computing device 102 to network interface 302d can be implemented in the form of an “Option 252” method associated with DHCP and/or DNS protocol. For example, computing device 102 may first send a query to a DHCP server for “Option 252”. If the DHCP server has “Option 252” configured, it may reply back to computing device 102 with configuration information (such as a URL) which can then be used to determine direct and/or proxy connections. If the DHCP does not have “Option 252”, it can either ignore the query (and subsequently time out) or reply that the option is not supported. Alternately or additionally, DNS name resolution can be used in a similar manner.

While interface 302d responds positively to computing device 102, network interfaces 302a-c all respond negatively, illustrated here by indication 308. A dashed line is used to represent indication 308 rather than the solid line used for indications 304 and 306. This dashed line designates that the negative responses from network interfaces 302a-c can either be sent by each respective network interface, and/or can be generated locally by computing device 102. In some embodiments, a network interface sends a message indicating a negative response to the query (e.g. an error message and/or a message stating “no support”). In other embodiments, the negative response can come in the form of a timeout message, either locally monitored and generated by computing device 102, or generated by the network interface and/or associated remote computer. Thus, indication 308 is received by computing device 102 at time “30 s”, whether received externally from an associated network interface, or generated and received internally. It is to be appreciated and understood that any combinations of indications and/or responses can be received. For instance, network interfaces 302a and b may send a “no support” message, while a response message from network interface 302c is generate by a time out.

While computing device 102 may choose to configure a connection based on a first response, in other embodiments, computing device 102 may choose to wait for a response (whether a positive response or negative) to all queries before configuring a connection. For instance, as discussed above, indication 308 represents negative responses from network interfaces 302a-c. In some cases, computing device 102 may wait to receive all of these responses (whether positive and/or negative) before choosing a connection based on information from network interface 302d. As previously described, these negative responses can be returned in the form of an error message, a “no support” message, a time-out message, and so forth. However, in some cases, multiple responses can be received from a network interface, and computing device 102 may choose to wait for at least a first message from each queried network interface before making an initial connection. For instance, a network interface may have at least two associated time-outs, where a first time-out is protocol-based (such as a longer DHCP time-out), and a (shorter) second time-out that is user- and/or application-based. At times, computing device 102 and/or an application may desire a shorter time-out in the interest of enabling faster connection times. Thus, in some cases, computing device 102 can wait for indication 308 from network interfaces 302a-c, which can, in some embodiments, represent a negative response associated with a user- and/or application-based time-out. Based upon this “snapshot” of the state of each response, computing device 102 would configure a connection based on network interface 302d. Here, the state is referred to as a “snapshot”, since at some point later in time, these network interfaces may return with a second response, whether a positive response or a negative response (such as the protocol-based timeout). At this later point in time, computing-device may then dynamically reconfigure to a different connection based upon what responses are returned and an associated priority of the network interface, as further described below.

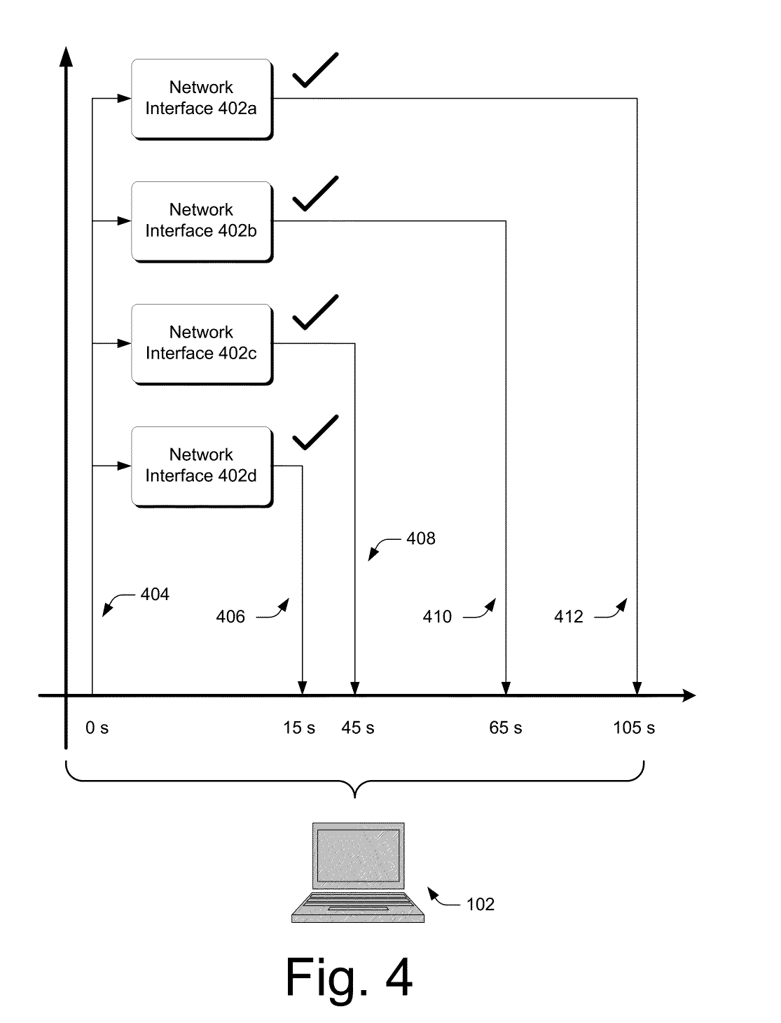

Continuing on, consider FIG. 4, which illustrates another example of parallel network interface probing in accordance with one or more embodiments. As in the case of FIG. 3, FIG. 4 depicts messaging that can occur between computing device 102 of FIGS. 1 and 2, and various network interfaces. Here, FIG. 4 includes network interfaces 402a-d. As also described with reference to FIG. 3, computing device 102 begins by sending four interface query messages in parallel to network interfaces 402a-d (e.g. at virtually the same time “0 s”), shown here as indication 404. However, in FIG. 4, each network interface responds in a positive manner to the query message. Network interface 402d responds first with indication 406 at 15 s, followed by network interface 402c with indication 408 at 45 s, network interface 402b with indication 410 at 65 s, and network interface 402a with indication 412 at 105 s. In some embodiments, computing device 102 can adaptively select which network interface to utilize and communicate with when multiple network interfaces respond, as further described below.

When receiving multiple positive responses to the parallel queries, computing device 102 can use an adaptive selection algorithm to select and/or prioritize the responding network interfaces. This can mean that computing device 102 may start a connection via a first network interface, but subsequently switch and/or reconfigure to different network interfaces when a higher priority network interface responds. Thus, in some embodiments, network interface selection is based, at least in part, on prioritizing the available network interfaces. The network interfaces can be prioritized in any suitable manner. For instance, the prioritization can be based upon a list of the network interfaces received by computing device 102. Alternately or additionally, choosing a network interface can be based, at least in part, on a network interface that yields the fastest response time. For example, computing device 102 may decide to use information returned by the first network interface in the interest of facilitating fast execution times. Here, the first positive responding network interface is network interface 402d with a response time of 15 s. Based upon this, computing device 102 decides to proceed with using the communication configuration information returned by network interface 402d. Upon receiving the second response from network interface 402c, computing device 102 evaluates network interface 402c and determines that it has a lower priority than network interface 402d. As such, computing device 102 maintains the connection based upon information returned by network interface 402d. However, upon receiving the third response from network interface 402b, computing device 102 determines that network interface 402b has a higher priority than the current one being used: network interface 402d. As such, computing device 102 reconfigures and/or switches connections from network interface 402d to network interface 402b. Continuing on with this example, when network interface 402a responds, computing device evaluates its priority against the one currently being used (now network interface 402b), and makes a determination whether to switch network interfaces. Thus, not only can network interface selection be based upon prioritization, but it can dynamically change based upon this prioritization and when network interfaces respond.

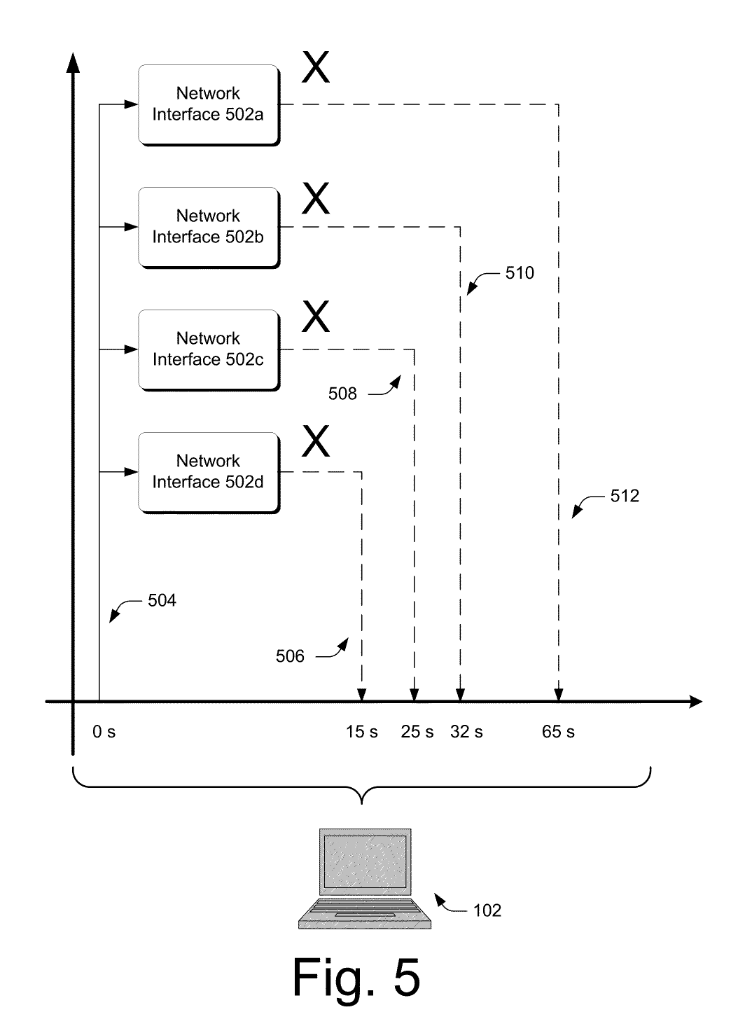

As another example, consider FIG. 5, which illustrates yet another example of parallel network interface probing in accordance with one or more embodiments. As in FIGS. 3 and 4, this example is discussed in the context of messaging between computing device 102 of FIGS. 1 and 2 and multiple network interfaces. Here, the multiple network interfaces are represented by network interfaces 502a-d. As in the other examples, computing device 102 begins by sending out parallel network interface queries to each network interface at time “0 s”, illustrated here as indication 504. However, in this example all of the network interfaces respond negatively, and at different time intervals: network interface 502d responds at time 15 s, network interface 502c responds at time 25 s, network interface 502b responds at time 32 s, and network interface 502a responds at time 65 s, illustrated here by indications 506, 508, 510, and 512 respectively. This variation in time can be due to a number of different items, such as differing processing routines on each of the interfaces, different receive times of the query by each network interfaces, different time-out settings and so forth. In some embodiments, there can be multiple time-outs associated with a query. For instance, some time-outs may be user-settable, where a user provides a desired value. Alternately or additionally, the time-out may be a standard time utilized by an associated protocol (e.g. DHCP time-out, etc.).

Using the example of FIG. 5, the above method of serially querying the multiple network interfaces would result in a total delay of 15+25+32+65=137 seconds before computing device 102 would be aware of each network interface responding negatively. However, using the parallel network interface probing, computing device 102 instead is aware in 65 seconds that no support is available. Thus, parallel network interface probing can improve responsiveness of a computing device, whether there are none, some, or all network interfaces available.

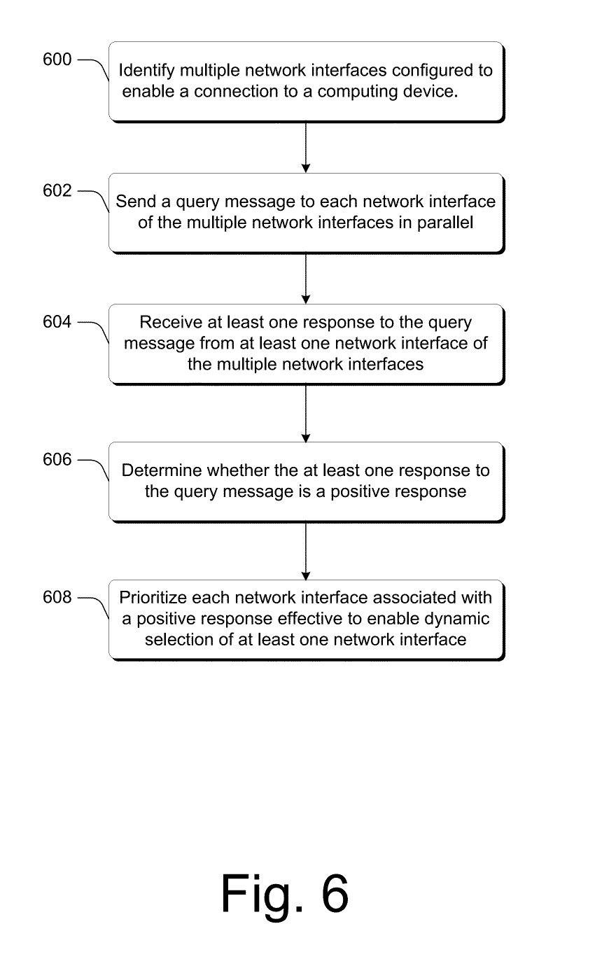

To further illustrate, consider FIG. 6, which illustrates a flow diagram that describes steps in a method in accordance with one or more embodiments. The method can be performed by any suitable hardware, software, firmware, or combination thereof. In at least some embodiments, aspects of the method can be implemented by one or more suitably configured software modules executing on one or more computing device, such as network discovery module 104, and/or parallel probing module 106, of FIG. 1.

Step 600 identifies multiple network interfaces configured to enable a connection to a computing device. In some embodiments, the network interfaces can be identified by a query to the computing device for all available network interfaces. In turn, an ordered list is received from the computing device, which can then be used for prioritization purposes as further described above and below.

Step 602 sends a query message to each network interface of the multiple network interfaces in parallel. In some embodiments, sending message in parallel comprises sending multiple messages without waiting for a response associated with the message. Each query message can include, among other things, a query for communication configuration information. For example, in some embodiments, the query for communication configuration information can comprise an “Option 252” query associated with identifying proxy client configuration settings.

Responsive to sending a query message to each network interface of the multiple network interfaces, step 604 receives at least one response to the query message from at least one network interface of the multiple network interfaces. In some cases, a received response comprises a positive response to the query. Alternately or additionally, the positive response can include at least some requested communication configuration information, a script, and/or data that points to additional information and/or scripts. In other cases, a received response comprises a negative response to the query. A negative response can be achieved in any suitable way, such as through timeout functionality and/or an error response returned by the associated network interface. Further, any suitable combination of positive and negative responses can be received, such as all positive responses, all negative responses, or any mixture of positive and negative responses.

Step 606 determines whether the at least one response to the query is a positive response. Responsive to determining the at least one response is a positive response, step 608 prioritizes each network interface associated with a positive response effective to enable dynamic selection of at least one network interface. In some embodiments, an adaptive selection algorithm can be used to prioritize, select, and/or switch selection of network interfaces, as further described above. For example, the highest priority network interface that has responded can be used to enable a connection. However, if a higher priority network interface responds at a later point in time, some embodiments can switch configurations and/or connections to reflect settings associated with the higher priority network interface.

Having considered a discussion of parallel and dynamic interface selection, consider now a discussion of an example device that can be utilized to implement the embodiments described above.

Example Device

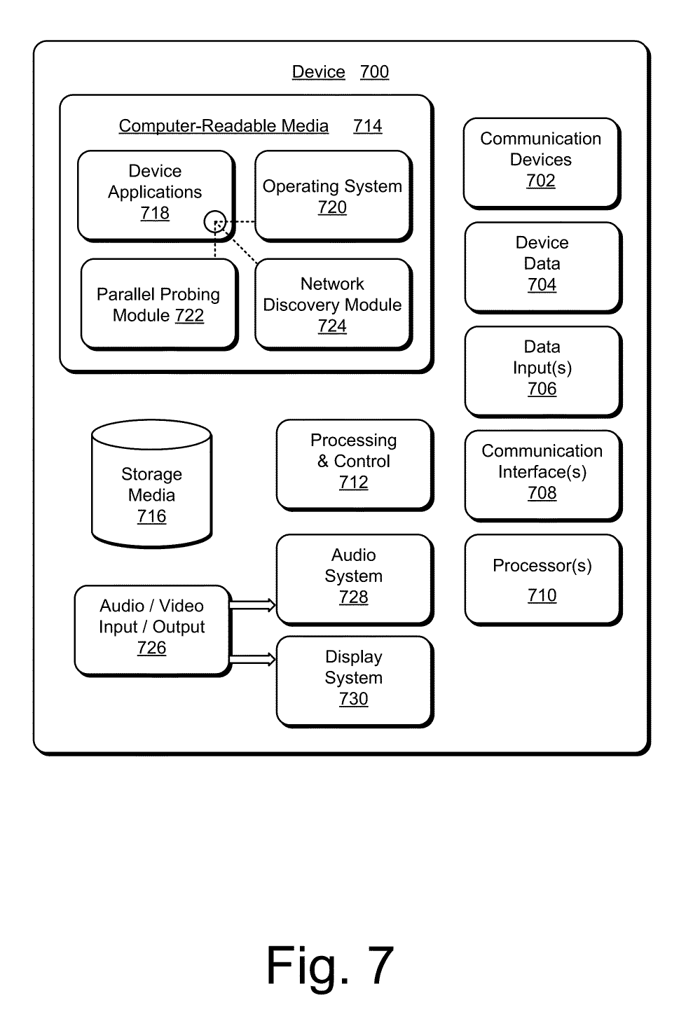

FIG. 7 illustrates various components of an example device 700 that can be implemented as any type of portable and/or computer device as described with reference to FIGS. 1 and 2 to implement embodiments of parallel and dynamic network selection described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable or readable instructions to control the operation of device 700 and to implement the embodiments described above. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 718 also include any system components or modules to implement embodiments of the techniques described herein. In this example, the device applications 718 include parallel probing module 722 and network discovery module 724 that are shown as software modules and/or computer applications. Parallel probing module 722 is representative of software that is used to enable parallel querying of multiple network interfaces, prioritization of connecting based on information from one of the network interfaces, and/or dynamically switching connections based upon the prioritization, as further described above. Network discovery module 724 is representative of software that enables device 700 to discover and/or find other computing devices and/or peripherals over a network. Alternatively or in addition, parallel probing module 722 and/or network discovery module 724 can be implemented as hardware, software, firmware, or any combination thereof.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### CONCLUSION

Various embodiments enable parallel querying of multiple network interfaces for communication configuration information. Returned communication configuration information can be used by a client device to enable communication with another computing device. In some embodiments, multiple responses to the parallel queries are received. Alternately or additionally, a response from a network interface can be determined through expiration of a user-configured timeout and/or a protocol configured timeout. Selection of a network interface from the multiple responses can be based, at least in part, on prioritizing the responding network interfaces using an adaptive selection algorithm.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
identifying multiple network interfaces configured to enable a connection to a computing device; and
sending a query message to each network interface of the multiple network interfaces in parallel effective to enable selection of one of the multiple network interfaces, wherein the query message is based, at least in part, on Dynamic Host Control Protocol (DHCP) discovery methods.

2. The computer-implemented method of claim 1 further comprising:
receiving user-input associated with setting a time-out associated with the query message; and
setting an expiration time associated with the time-out based, at least in part, on the user input.

3. The computer-implemented method of claim 2 further comprising:
receiving a negative response to the query from at least one network interface based, at least in part, on the time-out associated with user-input expiring.

4. The computer-implemented method of claim 1 further comprising:
receiving at least one response to the query message from at least one network interface of the multiple network interfaces;
determining whether the at least one response to the query message is a positive response; and
prioritizing each network interface associated with a positive response effective to enable dynamic selection of the at least one network interface, wherein prioritizing each network interface associated with a positive response effective to enable dynamic selection further comprises:
configuring the connection to the computing device based, at least in part, on information received via a first received positive response from a first network interface of the multiple interfaces;
receiving a second positive response from a second network interface of the multiple interfaces;
determining the second network interface has a higher priority than the first network interface; and
reconfiguring the connection to the computing device based, at least in part, on information received via the second positive response.

5. The computer-implemented method of claim 1 further comprising:
receiving at least one response to the query message from at least one network interface of the multiple network interfaces; and
responsive to determining at least one response to the query message is a positive response, configuring the connection to the computing device to route through at least one proxy based, at least in part, on information contained within the at least one response.

6. The computer-implemented method of claim 1, further comprising:
receiving at least one response to the query message from at least one network interface of the multiple network interfaces;
determining whether the at least one response to the query message is a positive response; and
prioritizing each network interface associated with a positive response effective to enable dynamic selection of the at least one network interface.

7. The computer-implemented method of claim 1, wherein the query message comprises an “Option 252” query.

8. The computer-implemented method of claim 1, wherein identifying the multiple network interfaces further comprises:
querying the computing device for available network interfaces; and
receiving a list of the available network interfaces.

9. One or more computer-readable storage memory embodying processor-executable instructions which, responsive to execution by at least one processor, are configured to:
identify multiple network interfaces configured to enable a connection to a computing device;
send a query message to each network interface of the multiple network interfaces in parallel;
receive at least one response to the query message from at least one network interface of the multiple network interfaces;
determine whether the at least one response to the query message is a positive response; and
prioritize each network interface associated with a positive response effective to enable dynamic selection of the at least one network interface.

10. The one or more computer-readable storage memory of claim 9 further comprising instructions configured to:
receive user-input associated with setting a time-out associated with the query message; and
set an expiration time associated with the time-out based, at least in part, on the user input.

11. The one or more computer-readable storage memory of claim 10 further comprising instructions configured to:
receive a negative response to the query from at least one network interface based, at least in part, on the time-out associated with user-input expiring.

12. The one or more computer-readable storage memory of claim 9, wherein the instructions to prioritize each network interface associated with a positive response effective to enable dynamic selection are further configured to:
configure the connection to the computing device based, at least in part, on information received via a first received positive response from a first network interface of the multiple interfaces;
receive a second positive response from a second network interface of the multiple interfaces;
determine the second network interface has a higher priority than the first network interface; and
reconfigure the connection to the computing device based, at least in part, on information received via the second positive response.

13. The one or more computer-readable storage memory of claim 9 further comprising instructions configured to:
responsive to determining at least one response to the query message is a positive response, configure the connection to the computing device to route through at least one proxy based, at least in part, on information contained within the at least one response.

14. The one or more computer-readable storage memory of claim 9, wherein the query message is based, at least in part, on Dynamic Host Control Protocol (DHCP) discovery methods.

15. The one or more computer-readable storage memory of claim 9, wherein the instructions to identify the multiple network interfaces are further configured to:
query the computing device for available network interfaces; and
receive a list of the available network interfaces.

16. A system comprising:
at least one processor;
one or more computer-readable storage memory embodying processor-executable instructions which, responsive to execution by at least one processor, are configured to:
identify multiple network interfaces configured to enable a connection to a computing device;
send a query message to each network interface of the multiple network interfaces in parallel;
receive at least one response to the query message from at least one network interface of the multiple network interfaces;
determine whether the at least one response to the query message is a positive response; and
prioritize each network interface associated with a positive response effective to enable dynamic selection of the at least one network interface.

17. The system of claim 16 further comprising instructions configured to:
receive user-input associated with setting a time-out associated with the query message; and
set an expiration time associated with the time-out based, at least in part, on the user input.

18. The system of claim 16, wherein the instructions to prioritize each network interface associated with a positive response effective to enable dynamic selection are further configured to:
configure the connection to the computing device based, at least in part, on information received via a first received positive response from a first network interface of the multiple interfaces;
receive a second positive response from a second network interface of the multiple interfaces;
determine the second network interface has a higher priority than the first network interface; and
reconfigure the connection to the computing device based, at least in part, on information received via the second positive response.

19. The system of claim 16 further comprising instructions configured to:
responsive to determining at least one response to the query message is a positive response, configure the connection to the computing device to route through at least one proxy based, at least in part, on information contained within the at least one response.

20. The system of claim 16, wherein the query message is based, at least in part, on Dynamic Host Control Protocol (DHCP) discovery methods.
